(19) United States
(12) Patent Application Publication
(10) Pub. No.: US 2013/0072341 A1
(43) Pub. Date: Mar. 21, 2013

(54) MULTI-SPEED GEAR SYSTEM FOR POWER TOOL

(71) Applicant: Ting-Kuang Chen, Keelung (TW)

(72) Inventor: Ting-Kuang Chen, Keelung (TW)

(73) Assignee: TOP GEARBOX INDUSTRY CO., LTD., Taoyuan County (TW)

(21) Appl. No.: 13/233,837

(22) Filed: Sep. 15, 2011

(51) Int. Cl. F16H 3/44

(52) U.S. Cl. 475/269

(57) ABSTRACT

A multi-speed gear system for a power tool includes a case, a lever, a gear disk, a movable member, a ring gear, a planet gear unit and an idle gear unit. The movable member is axially moved to be engaged with the ring gear, the planet gear unit or the idle gear unit to change the gear ratios and output different speeds. The parts that are engaged with the movable member are located outside of the area where the gears are located, so that the switching between the speeds is smooth and has less friction.

### BACKGROUND OF THE INVENTION

1. Field of the Invention

The present invention relates generally to a gear system for a power tool, and in particular to a gear system providing multiple outputs at high speed, mediate speed and low speed.

2. The Prior Arts

The conventional power tools, such as power drills and power screwdrivers, generally include a gear system for outputting power from a motor to an output shaft. In order to perform different tasks, most of the power tools have multi-speed gear system so as to control the output speeds and torques. The conventional gear system has a ring gear which is movable to be engaged with different gears having different numbers of teeth so as to provide two output speeds. If more than two output speeds are needed, at least two sets of switching devices are required. However, it increases the size and the ring gear is easily damaged during frequent engagements between gears.

### SUMMARY OF THE INVENTION

A primary objective of the present invention is to provide a multi-speed gear system for a power tool and the multi-speed gear system of the present invention does not require two sets of switching devices.

The characteristic of the present invention is that a multi-speed gear system for a power tool comprises a movable member which is axially movable while cannot rotate so as to be engaged with different parts in the gear system to change the ratios between the gears to output different speeds and torques. The parts that are engaged with the movable member are located outside of the area where the gears are located, so that the switching between the parts is smooth and has less friction.

A multi-speed gear system according to the present invention comprises a planet gear disk having an axial polygonal hole and a passive sun gear extends axially from the planet gear disk. A main shaft is a polygonal shaft which extends through the polygonal hole of the planet gear disk. Thus, the planet gear disk can co-rotate with the main shaft. A planet gear unit has a ring member and multiple planet gears, wherein the ring member has multiple inner teeth defined in the inner periphery thereof and multiple bosses extend from the outer periphery of the ring member. The planet gears each has a first step gear and a second step gear which is larger than the first step gear. The ring member is axially movable to engage with the planet gears. A ring gear has multiple inner teeth defined in the inner periphery thereof and multiple axial projections extend from one surface thereof and the inner teeth are engaged with the second step gear. An idle gear unit has an idle disk and multiple idle gears which are axially and movably connected to the idle disk. The idle gears are engaged with the inner teeth of the ring member. A driving member has a first end connected to the power source and the second end of the driving member has a driving sun gear which is engaged with the idle gears and the second step gear. A movable member has multiple hooks extending axially therefrom and the movable member is axially movable to control the hooks to hook the projections of the ring gear, to hook the bosses of the ring member, or to hook protrusions of the idle disk, thereby providing different output speeds. A case accommodates all the parts mentioned above.

Preferably, the case comprises a front casing and a rear casing. The rear casing includes multiple axial first grooves defined in the inner periphery thereof. The hooks of the movable member are slidably engaged with the first grooves.

Preferably, the rear casing comprises axial grooves and radial pivotal members respectively located on two sides thereof. A lever is pivotally connected to the two pivotal members and the movable member is connected to the lever so that when the lever is operated, the movable member is moved axially.

Preferably, the movable member comprises two pins respectively located on two sides thereof and the lever has two elongate holes respectively defined in two ends thereof. The two pins extend through the two elongate holes to connect the lever with the movable member.

Preferably, the planet gear unit comprises an end member which is connected to the ring member and mounted to cover the planet gears.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing a multi-speed gear system in accordance with the present invention;

FIG. 2 is a view, partly removed, to show the multi-speed gear system according to the present invention wherein the system is switched to output at high speed;

FIG. 3 is a perspective view showing a partial of the multi-speed gear system according to the present invention wherein the system is switched to output at high speed;

FIG. 4 is a plane schematic view to show the multi-speed gear system according to the present invention wherein the system is switched to output at high speed;

FIG. 5 is a perspective view, partly removed, to show the multi-speed gear system according to the present invention wherein the system is switched to output at mediate speed;

FIG. 6 is a plane schematic view to show the multi-speed gear system according to the present invention wherein the system is switched to output at mediate speed;

FIG. 7 is a perspective view, partly removed, to show the multi-speed gear system according to the present invention wherein the system is switched to output at low speed; and

FIG. 8 is a plane schematic view to show the multi-speed gear system according to the present invention wherein the system is switched to output at low speed.

### DETAILED DESCRIPTION OF THE PREFERRED EMBODIMENT

The parts mentioned hereinafter each have a first end and a second end which is located opposite to the first end. All of the first ends mentioned are the ends close to an output end at the front of the power tool and all of second ends mentioned are the ends away from the output end of the power tool.

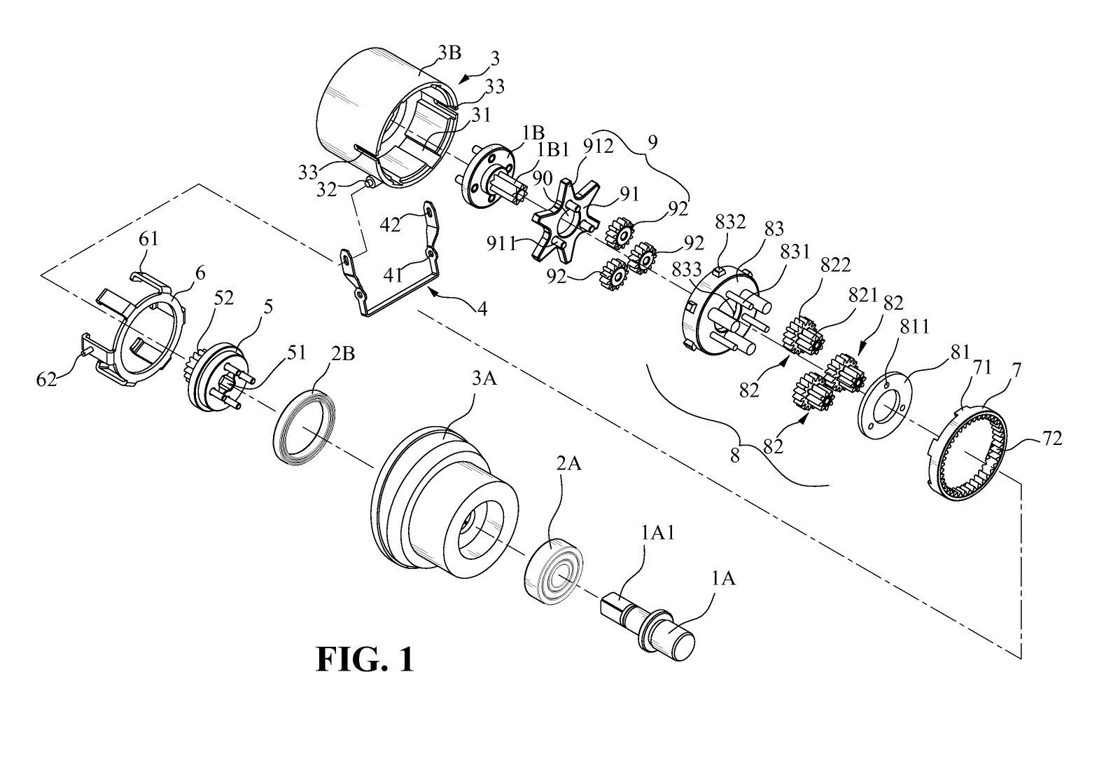

With reference to the drawings and in particular to FIG. 1, a multi-speed gear system for a power tool according to the present invention includes a case 3 which has a front casing 3A and a rear casing 3B. The front casing 3A accommodates a main shaft 1A, a first bearing 2A, a second bearing 2B and a planet gear disk 5. The planet gear disk 5 has an axial polygonal hole 51 and a passive sun gear 52 extends axially from the second end of the planet gear disk 5. The main shaft 1A has a polygonal shaft 1A1 corresponding to the polygonal hole 51 and extending from the second end thereof. The polygonal shaft 1A1 extends through the first bearing 2A and the polygonal hole 51. The planet gear disk 5 is cooperated with the second bearing 2B and both are accommodated in the front casing 3A so that the main shaft 1A and the planet gear disk 5 are co-rotatable in the front casing 3A.

The rear casing 3B accommodates a driving member 1B, an idle gear unit 9, a planet gear unit 8 and a ring gear 7. A movable member 6 is located in the case 3 and a lever 4 is connected outside of the rear casing 3B. The rear casing 3B includes a plurality of axial first grooves 31 defined in the inner periphery thereof. The rear casing 3B comprises axial grooves 33 and radial pivotal members 32 respectively located on two sides thereof. The center of the first end of the driving member 1B has a driving sun gear 1B1 extending axially therefrom and the second end of the driving member 1B is connected to the power source driven by a motor (not shown in drawings). The idle gear unit 9 has an idle disk 91 and a plurality of idle gears 92. A through hole 90 is defined through the center of the idle disk 91 which is a star-shaped member with a plurality of protrusions 912. The first end of the idle disk 91 has a plurality of extensions 911 and the idle gears 92 are respectively and rotatably mounted to the extensions 911. The driving sun gear 1B1 extends through the through hole 90 and is engaged with the idle gears 92. The planet gear unit 8 has a ring member 83, a plurality of planet gears 82 and an end member 81. The first end of the ring member 83 has a plurality of rods 831 extending axially therefrom and the second end includes an inner space which has a plurality of inner teeth 833 defined in the inner periphery of the inner space. The ring member 83 has a plurality of bosses 832 extending from the outer periphery thereof. Each of the planet gears 82 has a first step gear 821 and a second step gear 822 which has a larger diameter than the first step gear 821 does. The planet gears 82 are mounted to the rods 831, respectively. The rods 831 extend through holes 811 of the end member 81, respectively. The end member 81 is mounted to cover the ends of the planet gears 82 and the planet gear unit 8 is then installed in the rear casing 3B. The driving sun gear 1B1 is engaged with the second step gears 822 and the first step gears 821 are engaged with the passive sun gear 52. The ring gear 7 is a ring shaped member and has a plurality of inner teeth 72 defined in the inner periphery thereof. A plurality of evenly-spaced axial projections 71 extend axially from the second end of the ring gear 7. The ring gear 7 is fixed to the inner periphery of the rear casing 3B and the inner teeth 72 are engaged with the second step gear 822. The movable member 6 has a loop part and a plurality of hooks 61 extending axially from the second end of the movable member 6. The movable member 6 comprises two pins 62 respectively located on two sides thereof. The movable member 6 is installed in the case 3, so that the hooks 61 are slidably engaged with the first grooves 31 of the rear casing 3B, and the pins 62 are engaged with the second grooves 33. Therefore, the movable member 6 can be freely moved in axial direction in the case 3. The U-shaped lever 4 includes two circular holes 41 respectively defined in two sides thereof and two elongate holes 42 are respectively defined in two free ends thereof. The two circular holes 41 are pivotally mounted to the two pivotal members 32 of the rear casing 3B, and thus the lever 4 is pivotable relative to the rear casing 3B. The two pins 62 extend through the two elongate holes 42 via the second grooves 33 to connect the movable member 6 with the lever 4. Thus, the lever 4 can control the axial movement of the movable member 6.

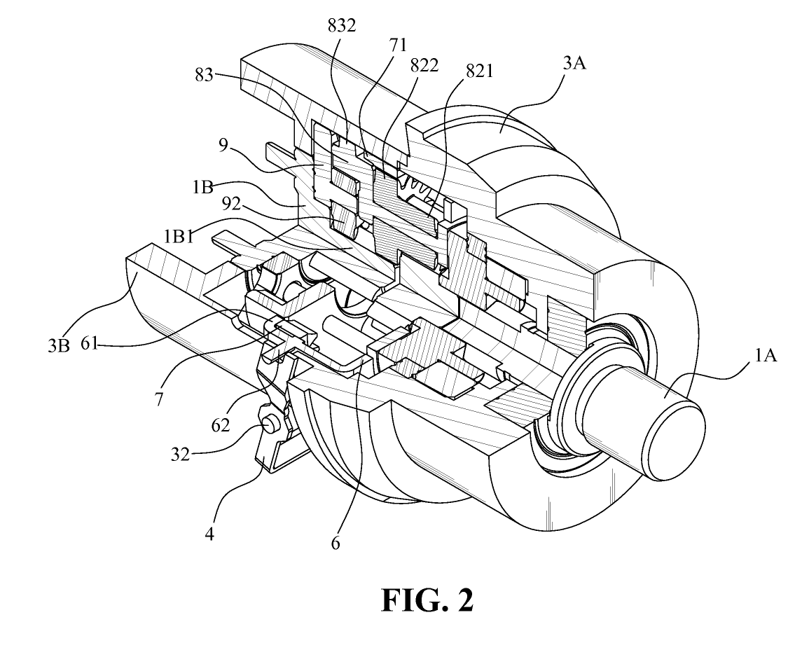

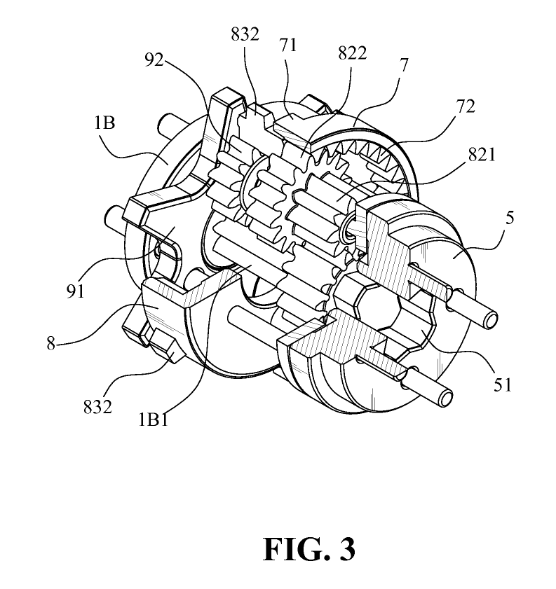

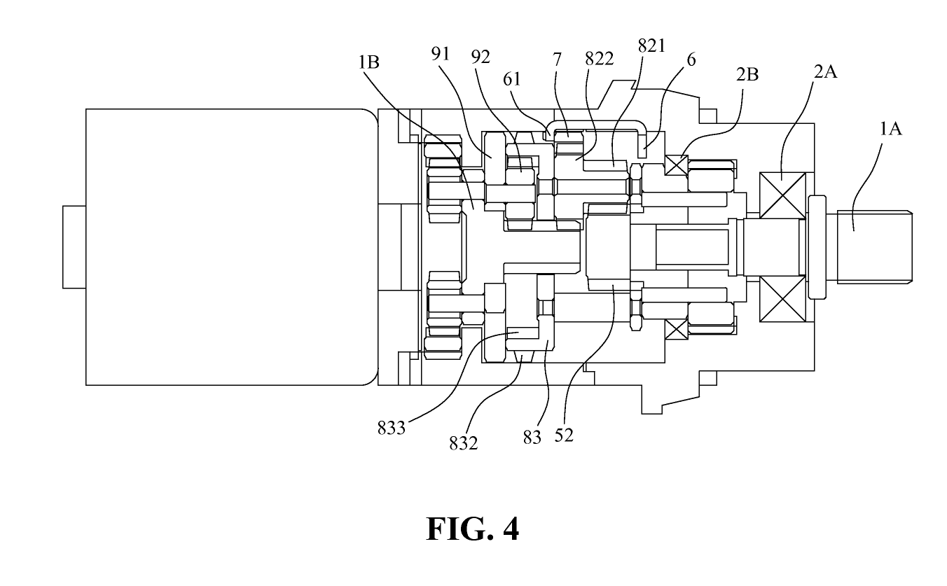

Referring to FIGS. 2 to 4, when the user shifts the lever 4 toward the second end, the movable member 6 is driven toward the first end and reaches the first position which generally is located at the very distal end of the first end. The hooks 61 of the movable member 6 hook the projections 71 of the ring gear 7, so that the ring gear 7 cannot rotate. Accordingly, the power source drives the driving sun gear 1B1 to rotate in the counterclockwise direction. Because the ring gear 7 cannot rotate, the driving sun gear 1B1, the planet gear unit 8 and the ring gear 7 form a sun-and-planet gear system. The planet gear unit 8 slowly rotates counterclockwise and the planet gear disk 5 rotates counterclockwise due to the driving sun gear 1B1 and the planet gear unit 8. Because the planet gear unit 8 and the planet gear disk 5 both rotate counterclockwise, the main shaft 1A outputs at high speed.

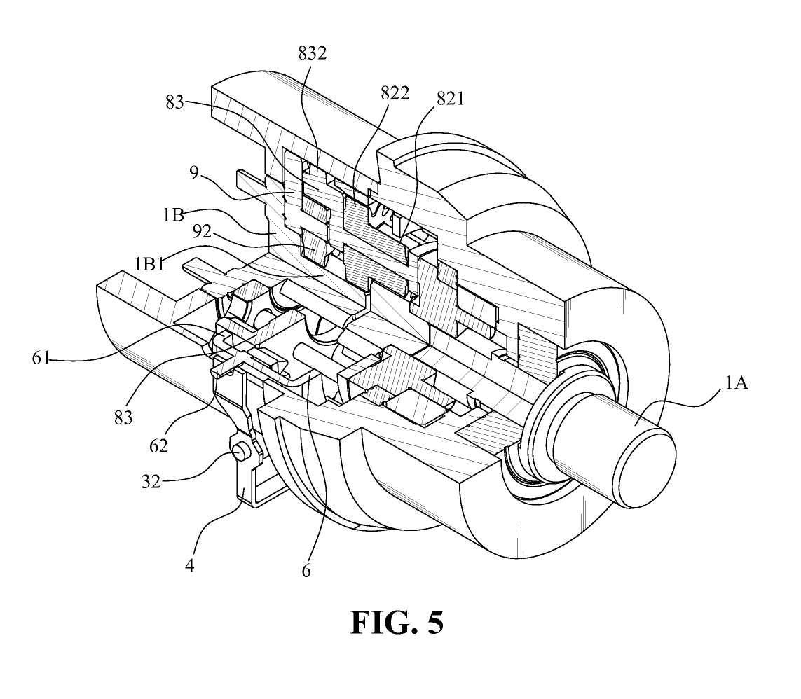

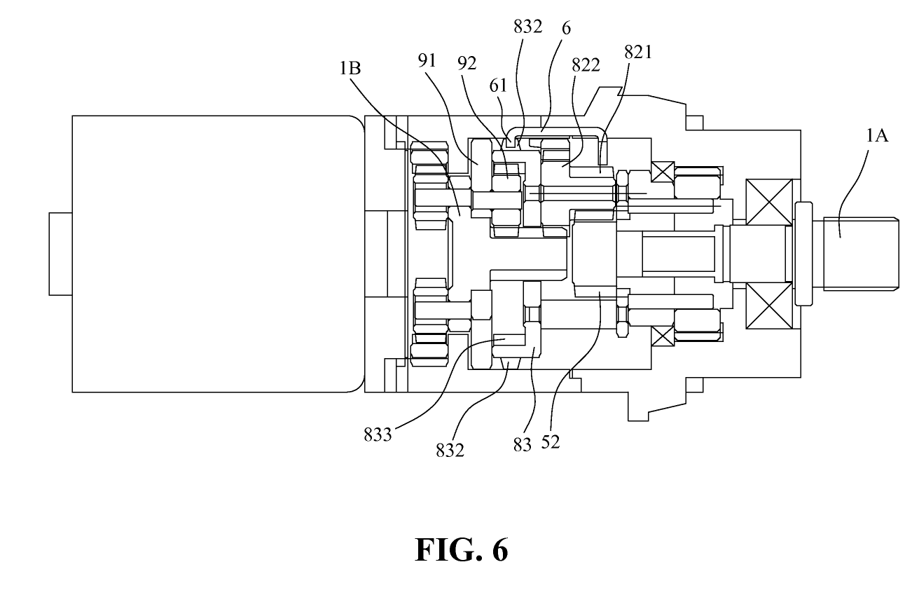

Referring to FIGS. 5 to 6, when the user shifts the lever 4 to move the movable member 6 to reach the second position which generally is located between the very distal ends of the first and second ends. The hooks 61 of the movable member 6 hook the bosses 832 of the ring member 83, so that the ring member 83 cannot rotate. Accordingly, the power source drives the driving sun gear 1B1 to rotate counterclockwise. Because the ring member 83 cannot rotate, the power is transferred to the planet gears 82 to drive the planet gear disk 5. The main shaft 1A outputs at mediate speed (1:1 gear ratio).

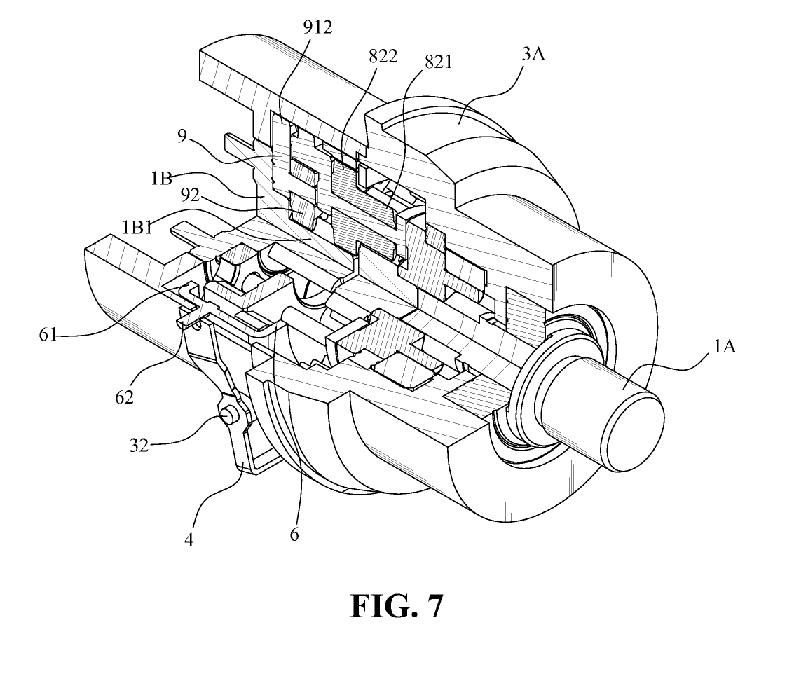

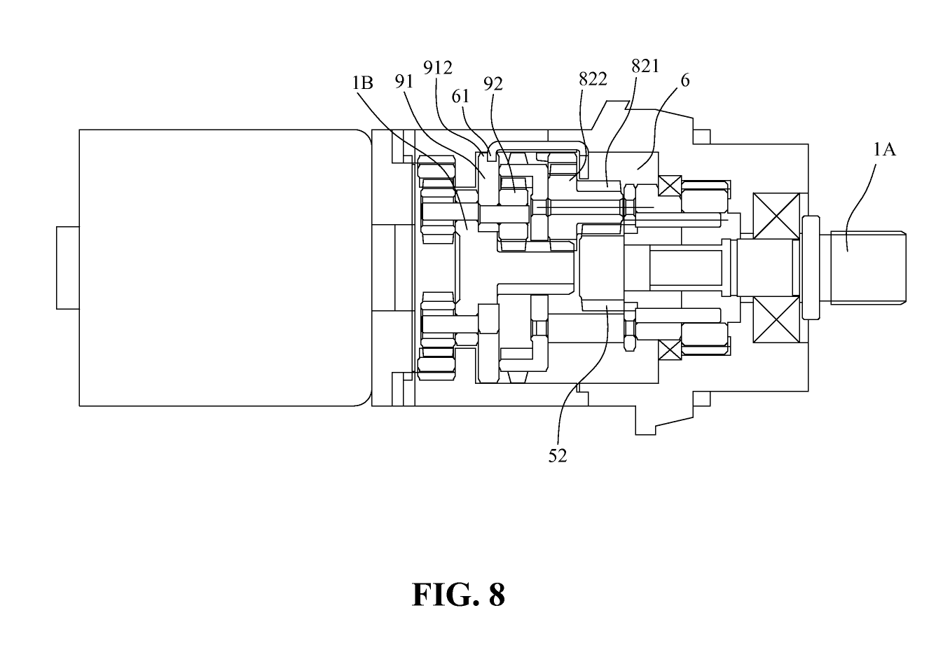

Referring to FIGS. 7 to 8, when the user shifts the lever 4 to move the movable member 6 to reach the third position which generally is located at the very distal end of the second end. The hooks 61 of the movable member 6 hook the protrusions 912 of the idle disk 91, so that the idle disk 91 cannot rotate. Accordingly, the power source drives the driving sun gear 1B1 to rotate counterclockwise. The ring member 83 is rotated clockwise at low speed. The planet gear disk 5 reduces its speed and rotates counterclockwise due to the opposite rotating directions of the driving sun gear 1B1 and the planet gear unit 8. The main shaft 1A outputs at low speed.

The advantage of the present invention is that the present invention does not require two sets of switching devices as conventional designs do. Thus, the multi-speed gear system according to the present invention occupies less space. Another advantage of the present invention is that the ring gear 7, the planet gear unit 8 and the idle gear unit 9 which are engaged with the movable member 6 are located outside of the area where the gears are located. Therefore, the switching between the speeds is smooth and has less friction.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multi-speed gear system, comprising:
a planet gear disk having an axial polygonal hole and a passive sun gear extending axially from the planet gear disk;
a main shaft having a polygonal shaft which extends through the polygonal hole of the planet gear disk;
a planet gear unit having a ring member and a plurality of planet gears, the ring member having a plurality of inner teeth defined in an inner periphery thereof and a plurality of bosses extending from an outer periphery of the ring member, the planet gears each including a first step gear and a second step gear which has a larger diameter than the first step gear does, the ring member axially movable to connect with the planet gears;
a ring gear having a plurality of inner teeth defined in an inner periphery thereof, a plurality of axial projections extending from an end thereof, the inner teeth of the ring gear engaged with the second step gear;
an idle gear unit having an idle disk and a plurality of idle gears which are axially and movably connected to the idle disk, the idle gears engaged with the inner teeth of the ring member;
a driving member having a first end adapted to be connected to a power source and a second end of the driving member having a driving sun gear which is engaged with the idle gears and the second step gears;
a movable member having a plurality of hooks extending axially therefrom and the movable member being axially movable to control the hooks to hook the projections of the ring gear, to hook the bosses of the ring member, or to hook protrusions of the idle disk; and
a case accommodating all the parts mentioned above.

2. The system as claimed in claim 1, wherein the case comprises a front casing and a rear casing, the rear casing includes a plurality of axial first grooves defined in an inner periphery thereof, the hooks of the movable member are slidably engaged with the first grooves.

3. The system as claimed in claim 2, wherein the rear casing comprises axial grooves and radial pivotal members respectively located on two sides thereof, a lever is pivotally connected with the two pivotal members, the movable member is connected to the lever so that the lever is capable of axially moving the movable member.

4. The system as claimed in claim 3, wherein the movable member comprises two pins respectively located on two sides thereof and the lever has two elongate holes respectively defined in two ends thereof, the two pins respectively extend through the two elongate holes to connect the lever with the movable member.

5. The system as claimed in claim 1, wherein the planet gear unit further comprises an end member which is connected to the ring member and mounted to cover the planet gears.
